(19) United States
(12) Patent Application Publication
(10) Pub. No.: US 2017/0254876 A1
(43) Pub. Date: Sep. 7, 2017

(54) ARRANGEMENT FOR, AND METHOD OF, SENSING TARGETS WITH IMPROVED PERFORMANCE IN A VENUE

(71) Applicant: SYMBOL TECHNOLOGIES, LLC, LINCOLNSHIRE, IL (US)

(72) Inventor: THOMAS E. WULFF, BROOKHAVEN, NY (US)

(21) Appl. No.: 15/062,271

(22) Filed: Mar. 7, 2016

(51) Int. Cl. G01S 5/02; H04N 5/225; H04N 5/77; H04N 7/18; G06K 7/10; G01S 5/18

(52) U.S. Cl. CPC G01S 5/0263; G06K 7/10366; G01S 5/0221; G01S 5/18; H04N 5/772; H04N 7/18; H04N 5/2253; H04N 5/2252

(57) ABSTRACT

Multiple sensing network units are deployed overhead in a venue. Each unit supports a video system for detecting a level of activity in the venue, and one or more sensing systems, such as an RFID system for reading RFID tags in the venue and/or an ultrasonic locationing system for locating mobile devices in the venue, in response to the activity level detected by the video system. The performance of the sensing systems is adjusted and optimized in response to the detected activity level.

### BACKGROUND OF THE INVENTION

The present disclosure relates generally to an arrangement for, and a method of, improving the performance of target sensing systems, such as a radio frequency (RF) identification (RFID) system for reading targets configured as RFID tags, and/or an ultrasonic locationing system for ultrasonically locating targets configured as mobile devices, and/or a video system for capturing video streams of images of targets, in a venue, and, more particularly, to a video-controlled arrangement for capturing target data from such RFID tags and mobile devices.

It is known to deploy a radio frequency (RF) identification (RFID) system in a retail, factory, or warehouse environment, or a like venue, for product locationing, product tracking, product identification, and inventory control. For example, in order to take an inventory of products associated with RFID tags in a warehouse environment or venue, it is known to position a plurality of RFID tag readers at overhead locations in the venue, and then, to operate each such reader, under the control of a network host computer or server, to form and steer an interrogation beam over a coverage range across any such tags to read their payloads. A multitude of tags may be in the coverage range of each reader. A specific location of any particular RFID-tagged product in the venue is typically determined by having the server process the payloads and capture data from a plurality of the readers by using triangulation/trilateration techniques known in the art.

Instead of an RFID system, it is also known to deploy an ultrasonic locationing system in the venue to capture data from, and determine the location of, mobile devices, such as handheld RFID tag readers, handheld bar code symbol readers, phones, radios, watches, tablets, radios, or computers, that are carried and/or worn by people movable within the venue. The mobile devices can also be product movers, such as trucks or forklifts, movable within the venue, for moving the products. For example, it is known to position a plurality of ultrasonic transmitters, e.g., speakers, virtually anywhere, preferably at overhead locations in the venue, and to drive the speakers, under the control of the network server, to determine the location of any such mobile device that contains an ultrasonic receiver, e.g., a microphone. Each ultrasonic speaker transmits an audio signal or ultrasonic energy in a short burst which is received by the microphone on the mobile device, thereby establishing the presence and specific location of each mobile device within the venue, again using triangulation/trilateration techniques known in the art.

Instead of the RFID and ultrasonic locationing systems, it is still further known to deploy a video or surveillance system in the venue by positioning a plurality of video cameras throughout the venue. Each video camera is operated, under the control of the network server, to capture a video stream of images of targets in its imaging field of view. The targets can be the aforementioned RFID-tagged products, and/or the RFID-tagged product movers for moving the RFID-tagged products, and/or the aforementioned mobile devices, and/or can even be people in the venue, such as employees or customers, under surveillance by the cameras. The employees may be carrying the aforementioned RFID-tagged products, and/or the aforementioned mobile devices, and/or may be operating the aforementioned product movers.

It is yet also known to install a wireless communications system by deploying a plurality of Wi-Fi access points for transmitting and receiving wireless communications throughout the venue. Wi-Fi is an available wireless standard for wirelessly exchanging data between electronic devices, thereby establishing a local area network in the venue.

Although the known RFID, ultrasonic locationing, video, and communications systems have all been generally satisfactory for their intended purposes, the performance of the RFID system at a venue could sometimes suffer and degrade due to RF interference among all the RFID tag readers deployed at the same venue, all competing for the same RF spectrum. Likewise, the performance of the ultrasonic locationing system at a venue could sometimes suffer and degrade due to acoustic interference among all the ultrasonic speakers deployed at the same venue, all transmitting simultaneously. Such RF and acoustic interference were made especially worse in a venue where there was a multitude of RFID readers and/or speakers, and where the venue had multiple zones with multiple surfaces, e.g., walls, off which the RF/ultrasonic signals were reflected and/or scattered along multiple paths.

Accordingly, it would be desirable to reduce RF and acoustic interference in a venue where an RFID system and/or an ultrasonic locationing system are deployed, as well as to improve the performance of such systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a broken-away, perspective view, as seen from above, of an arrangement of multiple, overhead, sensing network units deployed in a warehouse venue in accordance with the present disclosure.

FIG. 2 is a perspective view, as seen from below, of a preferred embodiment of a representative one of the sensing network units of FIG. 1.

FIG. 3 is an elevational view of the unit of FIG. 2.

FIG. 4 is a bottom plan view of the unit of FIG. 2, and showing a bottom access door in a closed position.

FIG. 5 is a perspective view of the unit of FIG. 2, and showing the bottom access door in an open position.

FIG. 6 is a broken-away, enlarged, sectional view of the unit of FIG. 2, and showing the interior of the unit.

FIG. 7 is a block diagram showing the electrical connections among various built-in systems mounted in the interior of the unit of FIG. 2.

FIG. 8 is a flow chart of a method of improving performance of target sensing systems in accordance with the present disclosure.

FIG. 9 is a diagrammatic top plan view depicting one example of how the performance of an RFID system can be improved at a representative sensing network unit.

FIG. 10 is a diagrammatic top plan view depicting one example of how the performance of an ultrasonic locationing system can be improved at a representative sensing network unit.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for sensing targets with improved performance in a venue, such as a retail, factory, or warehouse environment. The arrangement includes a network host computer or server, a video system deployed in the venue, and a sensing system also deployed in the venue. The video system is operatively connected to, and controlled by, the network server, and is operative for detecting a level of activity in the venue. The sensing system is operatively connected to, and controlled by, the network server, and is operative for sensing the targets in the venue in response to the activity level detected by the video system.

Advantageously, the sensing system is a radio frequency (RF) identification (RFID) system operative for reading the targets configured as RFID tags in a reading mode of operation with a set of reading parameters, and/or a locationing system operative for ultrasonically locating the targets configured as mobile devices in a locating mode of operation with a set of locating parameters. Preferably, the RFID system, the locationing system, and the video system are all mounted in a common housing mounted at a single overhead location in at least one zone of the venue. The network server changes at least one of the reading parameters and/or one of the locating parameters based on the activity level detected by the video system.

For example, the network server at least partially deenergizes or controls the RFID system to not read any RFID tags, or to read fewer RFID tags, when no or a zero or a reduced level of activity is detected by the video system, and changes at least one of the reading parameters, e.g., a dwell time in which an RF signal transmitted by the RFID system reads each RFID tag, based on the activity level detected by the video system. Thus, a high detected level of activity, e.g., a lot of motion caused by many moving targets, will cause the network server to increase the dwell time, and vice versa. Other reading parameters that can be changed include, but are not limited to, a transmit power at which the RF signal is transmitted, and/or a transmit direction along which the RF signal is transmitted, and/or a firing order of a plurality of RF signals that are transmitted by a plurality of RFID antennas. As another example, the network server at least partially deenergizes or controls the locationing system to not locate any mobile devices, or to locate fewer mobile devices, when no or a zero or a reduced level of activity is detected by the video system, and changes at least one of the locating parameters, e.g., a transmit time in which an ultrasonic signal transmitted by the locationing system locates each mobile device, based on the activity level detected by the video system. Thus, a high detected level of activity, e.g., a lot of motion caused by many moving targets, will cause the network server to increase the transmit time, and vice versa. Other locating parameters that can be changed include, but are not limited to, a transmit power at which the ultrasonic signal is transmitted, and/or a transmit direction along which the ultrasonic signal is transmitted, and/or a drive order of a plurality of ultrasonic signals that are transmitted by a plurality of ultrasonic transmitters.

A further aspect of this disclosure is directed to a method of sensing targets with improved performance in a venue. The method is performed by deploying and operating a video system in the venue to detect a level of activity in the venue, and by deploying and operating a sensing system in the venue to sense the targets in the venue in response to the activity level detected by the video system.

In accordance with this disclosure, the video system provides additional control, information, and feedback to the RFID system and/or the locationing system to improve their data capture performance. When the video system detects no or a reduced level of activity in a particular zone of the venue, there is no reason for the RFID system and/or the locationing system in that zone to operate at full performance, and, therefore, they can be at least partially deenergized, thereby reducing, if not eliminating, RF and acoustic interference. As the video system detects greater and greater levels of activity in a particular zone of the venue, then the aforementioned dwell and transmit times can be proportionally directly increased to accommodate the greater levels of activity, and vice versa, thereby optimizing the data capture performance of the video-controlled, RFID system and/or locationing system.

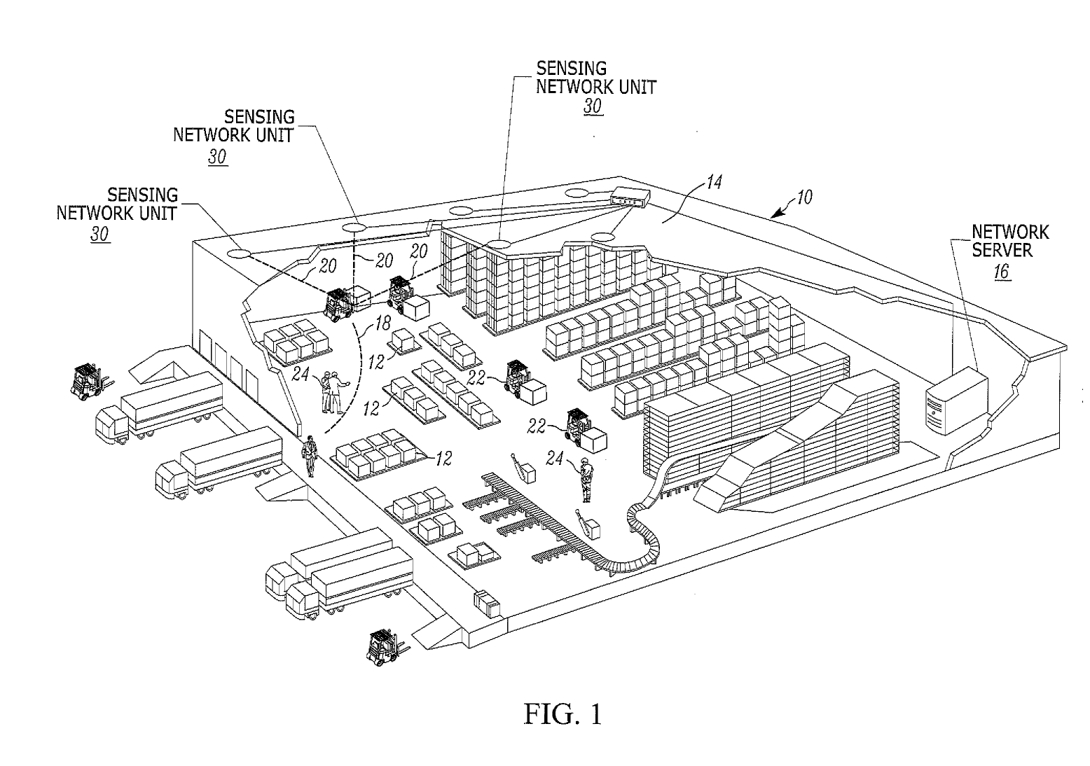

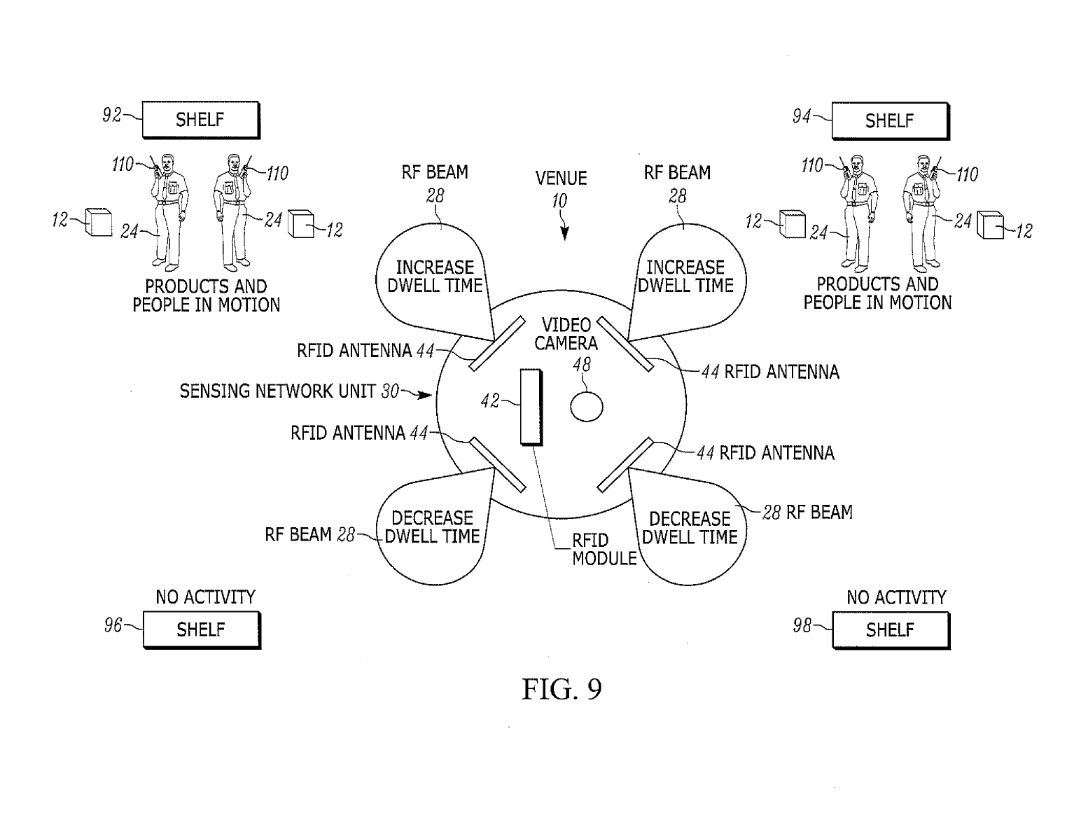

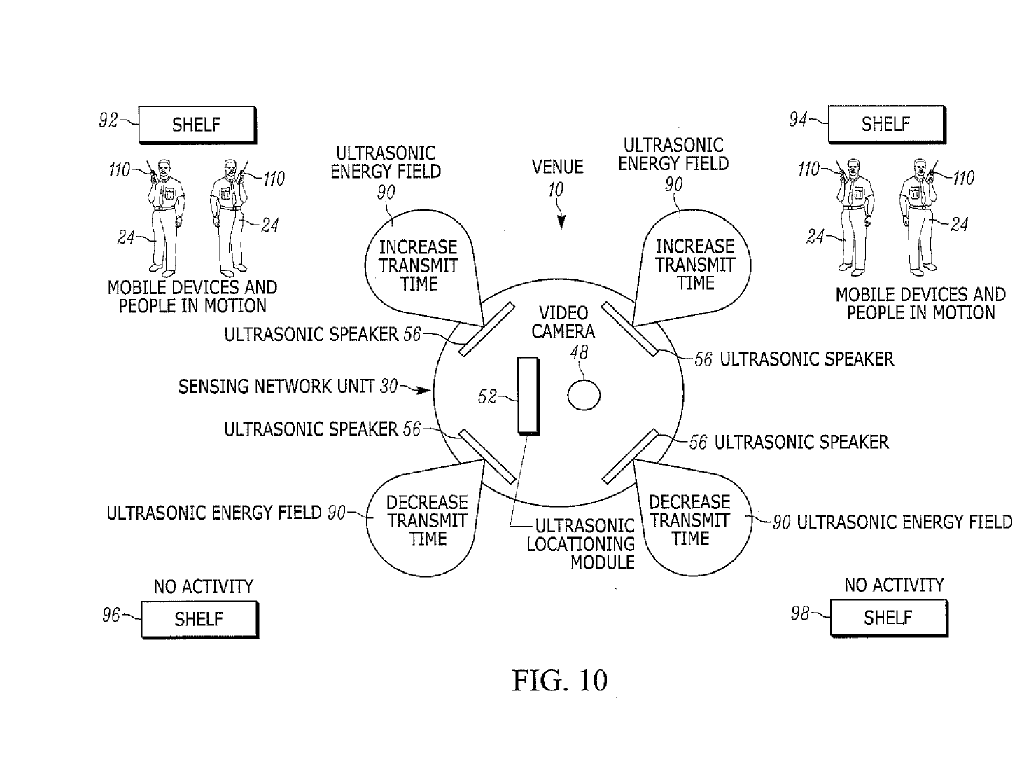

Turning now to the drawings, reference numeral 10 in FIG. 1 generally depicts a warehouse environment or venue in which a plurality of sensing network units 30 for sensing targets is mounted overhead on a ceiling 14. As described below in connection with FIGS. 9-10, the venue 10 may have zones or shelves 92, 94, 96, 98 spaced apart from one another. Advantageously, the sensing network units 30 can be installed every twenty to eighty feet or so in a square grid. As described below, each sensing network unit 30 has a video system for capturing video streams of images of targets, such as the illustrated products 12, forklifts 22, and people 24, and one or more target sensing systems, such as a radio frequency (RF) identification (RFID) system operative for reading targets configured as RFID tags, and/or a locationing system operative for ultrasonically locating targets configured as mobile devices 110. Each product 12 is tagged with an RFID tag, preferably a passive RFID tag for cost reasons, and, in some applications, each RFID tag may be associated with a pallet or a container for multiple products 12. The mobile devices 110 can be handheld RFID tag readers, handheld bar code symbol readers, phones, radios, watches, tablets, radios, or computers, which are carried and/or worn by the people 24 movable within the venue 10. The mobile devices 110 can also be product movers, such as the trucks or forklifts 22, movable within the venue 10, for moving the products 12. The forklifts 22 can also be RFID-tagged. The aforementioned shelves 92, 94 are described hereinafter as “busy” shelves, because there are many products 12, people 24, and mobile devices 110 at these zones, whereas shelves 96, 98 are described hereinafter as “idle” shelves, because there are no or fewer products 12, people 24, and mobile devices 110 at these zones.

A network host computer or server 16, typically locally located in a backroom at the venue 10, comprises one or more computers and is in wired, wireless, direct, or networked communication with each sensing network unit 30. The server 16 may also be remotely hosted in a cloud server. The server 16 may include a wireless RF transceiver that communicates with each sensing network unit 30. For example, Wi-Fi and Bluetooth® are open wireless standards for exchanging data between electronic devices. The server 16 controls the video, RFID, and locationing systems in each sensing network unit 30. As diagrammatically shown by the dashed lines 20 in FIG. 1, three of the sensing network units 30 can be used to locate a product 12 in the venue 10 by triangulation or trilateration, as well as a route, shown by dashed lines 18, along which the product 12 has traveled.

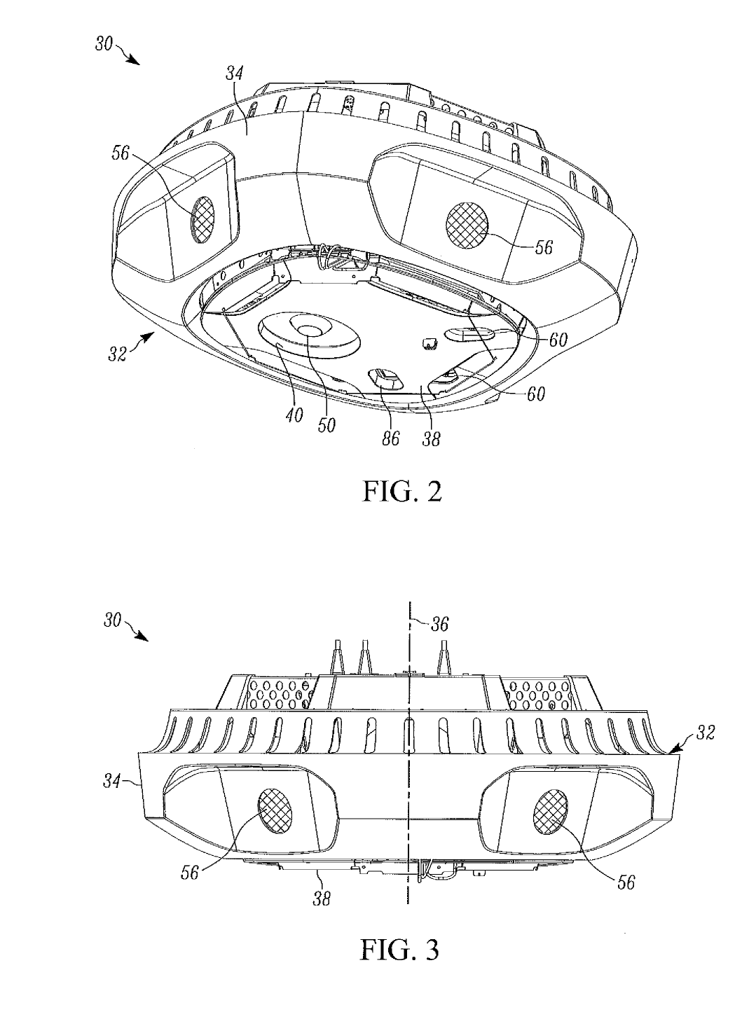

A preferred embodiment of each sensing network unit 30 is depicted in FIGS. 2-7. Each unit 30 has a generally circular, hollow, common housing 32 mounted at an overhead location in a zone of the venue 10. Preferably, an upright, vertical post 80 extends downwardly from the ceiling 14, and a lower end of the post 80 is connected to an apertured plate or cage 82 that is attached to a bracket 84 that, in turn, is connected to the housing 32. The housing 32 has an outer wall 34 bounding an upright, vertical axis 36 and a bottom wall, which is configured as a hinged access door 38. The door 38 has a generally circular opening 40. The housing 32 supports a plurality of electrically-powered sensor modules operative for sensing targets in the venue 10, and for generating and capturing target data indicative of the targets.

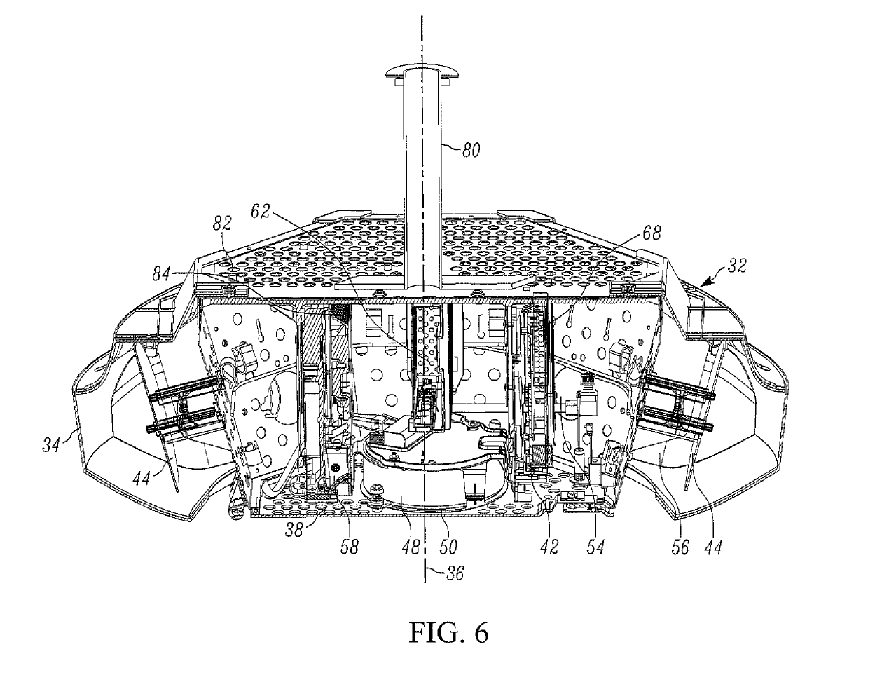

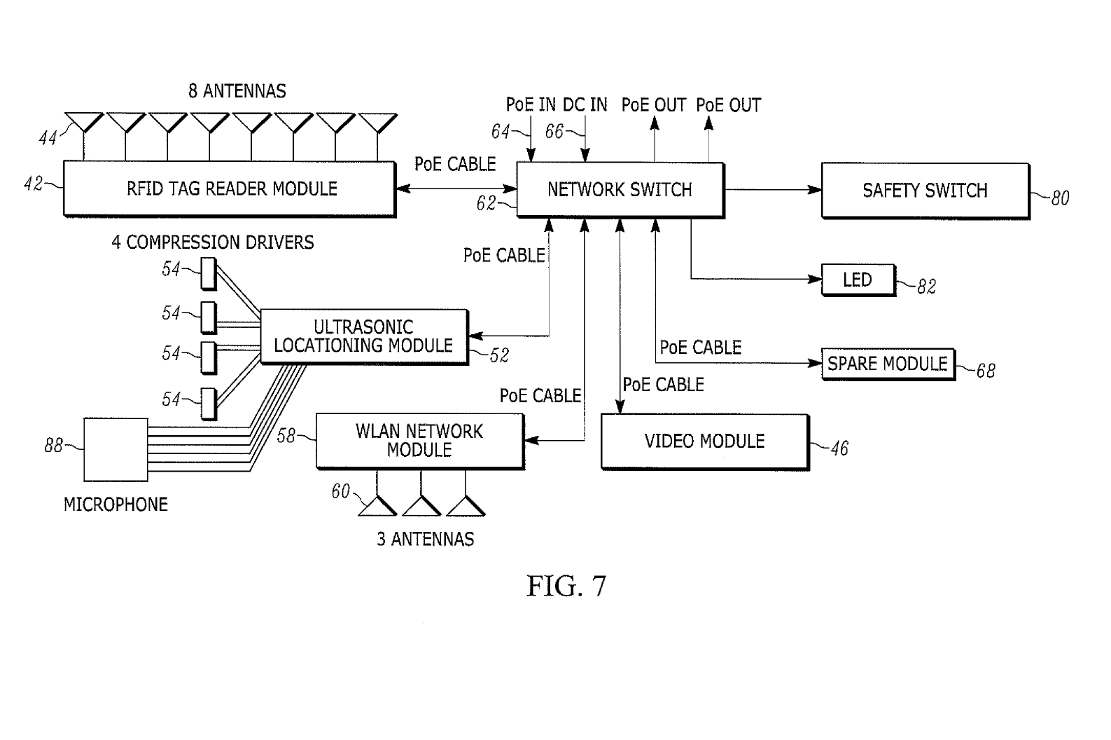

As best shown in FIG. 7, one of the sensor modules is a component of the RFID system and constitutes an RFID tag reader module 42 that is interchangeably mounted within the housing 32, for reading targets configured as RFID tags in the venue 10 over its coverage range. The RFID module 42 includes control and processing electronics that are operatively connected to a plurality of RFID antennas 44, which are energized by the RFID module 42 in a firing order. The RFID module 42 includes an RF transceiver operated, under the control of the server 16, to form and steer an interrogating RF beam 28 (see FIG. 9) across, and interrogate and process the payloads of, any RFID tags that are in its coverage range. It will be understood that there may be thousands of RFID tags in the venue 10. The RFID antennas 44 receive a return RF beam from the interrogated tag(s), and the RFID module 42 decodes an RF signal from the return RF beam, under the control of the server 16, into decoded data. The decoded data, also known as a payload or captured target data, can denote a serial number, a price, a date, a destination, a location, other attribute(s), or any combination of attributes, and so on, for the tagged product. As best shown in FIG. 6, the RFID antennas 44 are mounted inside the housing 32 and are arranged, preferably equiangularly spaced apart, about the upright axis 36. The outer wall 34 covers the RFID antennas 44 and acts as a radome to protect the RFID antennas 44. The outer wall 34, as well as the housing 32, is constituted of a material, such as plastic, through which RF signals can readily pass.

As also shown in FIG. 7, another of the sensor modules is a component of the video system and constitutes a video module 46 interchangeably mounted within the housing 32, and operatively connected to a camera 48, also mounted within the housing 32. The video module 46 includes camera control and processing electronics for capturing a video stream of images of targets, also known as captured target data, in the zone of the venue 10 over an imaging field of view at a frame rate and a resolution. Preferably, the frame rate and/or the resolution are adjustable. The targets can, for example, be the aforementioned RFID-tagged products 12, and can even be people 24, such as an employee or customers, under surveillance by the camera 48. The camera 48 has a lens 50 that faces, and is optically aligned with, the opening 40 in the access door 38. The camera 48 is advantageously a high-bandwidth, moving picture expert group (MPEG) compression camera.

As further shown in FIG. 7, still another of the sensor modules is a component of the locationing system and constitutes an ultrasonic locationing module 52 interchangeably mounted within the housing 32, for locating targets configured as mobile devices 110 in the venue 10 by transmitting and receiving ultrasonic energy fields 90 (see FIG. 10) between the ultrasonic locationing module 52 and the mobile devices. The mobile devices can be handheld RFID tag readers, handheld bar code symbol readers, smartphones, tablets, watches, computers, radios, or the like, each device being equipped with a transducer, such as a microphone. The locationing module 52 includes control and processing electronics operatively connected to a plurality of compression drivers 54 and, in turn, to a plurality of ultrasonic transmitters, such as voice coil or piezoelectric speakers 56. The ultrasonic speakers 56 are preferably mounted on the outer wall 34 and are arranged, preferably equiangularly spaced apart, about the upright axis 36. The ultrasonic speakers 56 are driven by the locationing module 52 in a drive order. A feedback microphone 88 may also be mounted on the outer wall 34.

As still further shown in FIG. 7, still another of the modules may be a wireless local area network (WLAN) communications module 58 interchangeably mounted within the housing 32, for wireless communication over a network at the venue 100. The communications module 58 includes control and processing electronics that are operatively connected to a plurality of WLAN antennas 60 that are mounted, and spaced apart, on the housing 32. The communications module 58 serves as a Wi-Fi access point for transmitting and receiving wireless communications throughout the venue 10. Wi-Fi is an available wireless standard for wirelessly exchanging data between electronic devices, thereby establishing a local area network in the venue.

Each ultrasonic speaker 56 periodically transmits ultrasonic ranging signals, preferably in short bursts or ultrasonic pulses, which are received by the microphone on the mobile device. The microphone determines when the ultrasonic ranging signals are received. The communications module 58 advises the ultrasonic locationing module 52 when the ultrasonic ranging signals were received. The locationing module 52, under the control of the server 16, directs all the speakers 56 to emit the ultrasonic ranging signals in the drive order such that the microphone on the mobile device will receive minimized overlapping ranging signals from the different speakers. The flight time difference between the transmit time that each ranging signal is transmitted and the receive time that each ranging signal is received, together with the known speed of each ranging signal, as well as the known and fixed locations and positions of the speakers 56 on each sensing unit 30, are all used to determine the position of the microphone mounted on the mobile device, and, in turn, the position of the mobile device, also known as captured target data, using a suitable locationing technique, such as triangulation, trilateration, multilateration, etc.

A power and data distribution system is employed for transmitting network control data and electrical power to the sensor modules 42, 46, 52, and for transmitting the captured target data away from the sensor modules 42, 46, 52. The power and data distribution system includes a networking control switch 62 mounted within the housing 32, an exterior power and data cable, preferably a Power-over-Ethernet (PoE) cable, connected between each unit 30 and the server 16, and a plurality of interior PoE cables each connected between a respective module 42, 46, 52, 58 and the networking control switch 62. Each PoE cable connected to the modules 42, 46, 52 transmits the electrical power and transmits the control data thereto from the networking control switch 62, and transmits the target data away from the respective module 42, 46, 52 to the networking control switch 62. The PoE cable connected to the communications module 58 transmits the electrical power and transmits the control data thereto from the networking control switch 62, and transmits communications data away from the communications module 58 back to the server 16.

The exterior PoE cable is connected between a power source (not illustrated) and an input port 64 on the networking control switch 62. An optional DC power line 66 can be connected to the networking control switch 62. A spare module 68 can be accommodated within the housing 32. The spare module can be another sensor module, or, advantageously, can be another communications module operating under a different protocol, such as the Bluetooth® protocol or the ultra wideband protocol.

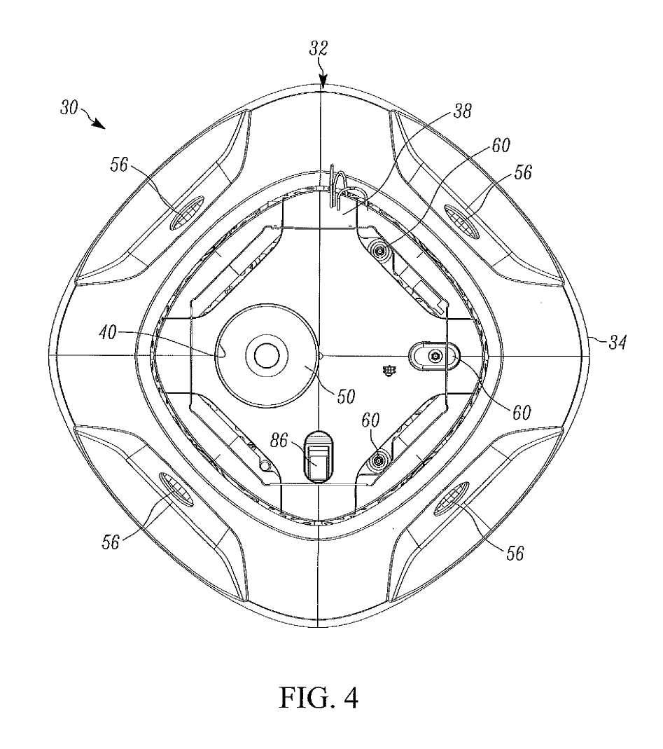

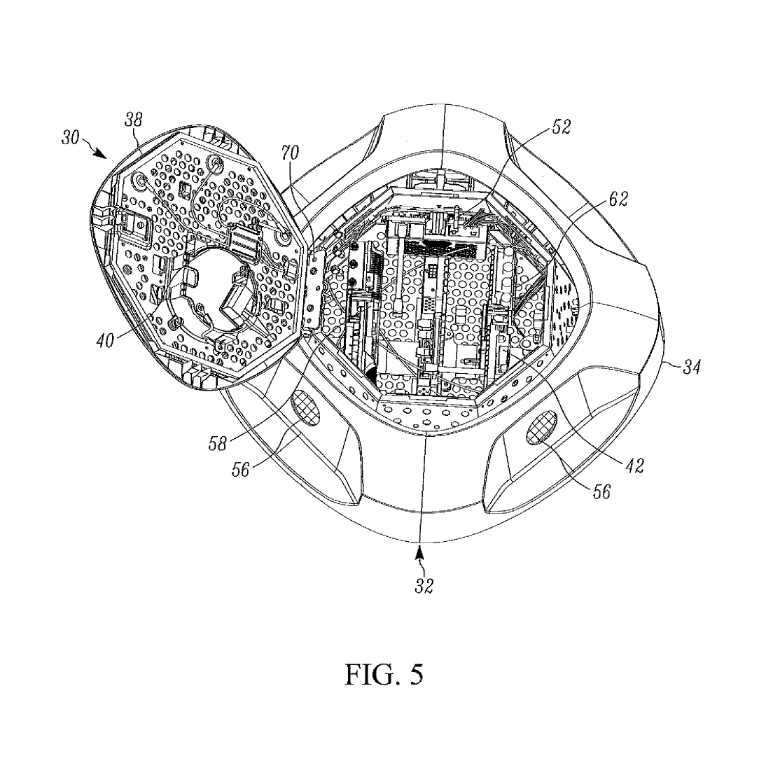

The aforementioned access door 38 is hinged at hinge 70 to the housing 32 for movement between an open position (FIG. 5) and a closed position (FIG. 4). A slide switch 86 is moved to unlock the access door 38. In the open position shown in FIG. 5, the modules 42, 52, 58 are all accessible to be installed in the housing 32, or to be removed from the housing 32 and replaced with another module for maintenance and repair.

A safety switch 80 (see FIG. 7) senses the position of the door 38, and discontinues or cuts the electrical power to the modules when the door 38 is in the open position. An indicator 82, e.g., a light emitting diode (LED), visually signals that the electrical power has been cut off

In accordance with this disclosure, the video system provides additional control, information, and feedback to the RFID system and/or the locationing system to improve their data capture performance. The camera 48 in each unit 30 monitors the activity level of any targets in its imaging field of view or zone in the venue 10. When the camera 48 detects no or zero or a reduced level of activity in a particular zone of the venue 10, e.g., at idle shelves 96, 98, then there is no reason for the RFID system and/or the locationing system in that zone to operate to capture target data at full performance, and, therefore, they can be at least partially deenergized by the server 16, thereby reducing, if not eliminating, RF and acoustic interference. As the camera 48 detects greater and greater levels of activity in a particular zone of the venue 10, e.g., at busy shelves 92, 94, then the operation of the RFID system and/or the locationing system in that zone is modified by the server 16 to accommodate the greater levels of activity, and vice versa, thereby optimizing the data capture performance of the video-controlled, RFID system and/or locationing system.

For example, the RFID system reads the RFID tags in a reading mode of operation with a set of reading parameters or settings. One such reading parameter is the duration of a dwell time of an RF interrogation signal transmitted by the RFID system. The dwell time is the length of time that an RFID tag stays in the field 28 of the RF interrogation beam. The network server 16 varies the dwell time, or any other reading parameter or setting, based on the activity level detected by the video system. Thus, a higher detected level of activity, e.g., more motion caused by many moving targets, for example, at busy shelves 92, 94, will cause the network server 16 to directly proportionately increase the dwell time, or any other reading parameter, and vice versa. Other reading parameters that can be changed include, but are not limited to, a transmit power at which the RF signal is transmitted, and/or a transmit direction along which the RF signal is transmitted, and/or a firing order of a plurality of RF signals that are transmitted by the RFID antennas 44. Any one or more of such reading parameters can be varied in any combination.

Analogously, the locationing system locates the mobile devices in a locating mode of operation with a set of locating parameters or settings. One such reading parameter is the duration of a transmit time of an ultrasonic signal transmitted by the locationing system. The transmit time is the length of time that a mobile device is located in the presence of the ultrasonic signal. The network server 16 varies the transmit time, or any other locating parameter or setting, based on the activity level detected by the video system. Thus, a higher detected level of activity, e.g., more motion caused by many moving targets, for example, at busy shelves 92, 94, will cause the network server 16 to directly proportionately increase the transmit time, or another parameter, and vice versa. Other locating parameters that can be changed include, but are not limited to, a transmit power at which the ultrasonic signal is transmitted, and/or a transmit direction along which the ultrasonic signal is transmitted, and/or a drive order of a plurality of ultrasonic signals that are transmitted by a plurality of ultrasonic speakers 56. Any one or more of such locating parameters can be varied in any combination.

The RFID and the locationing systems need not be independently operative of each other, but could mutually cooperate with other to accurately locate the targets. For example, the RFID module may determine the general location or neighborhood of the tag with a certain level of accuracy, and the locationing module may determine the location of the tag with a higher or finer level of accuracy by locating the person who is holding or moving the tag.

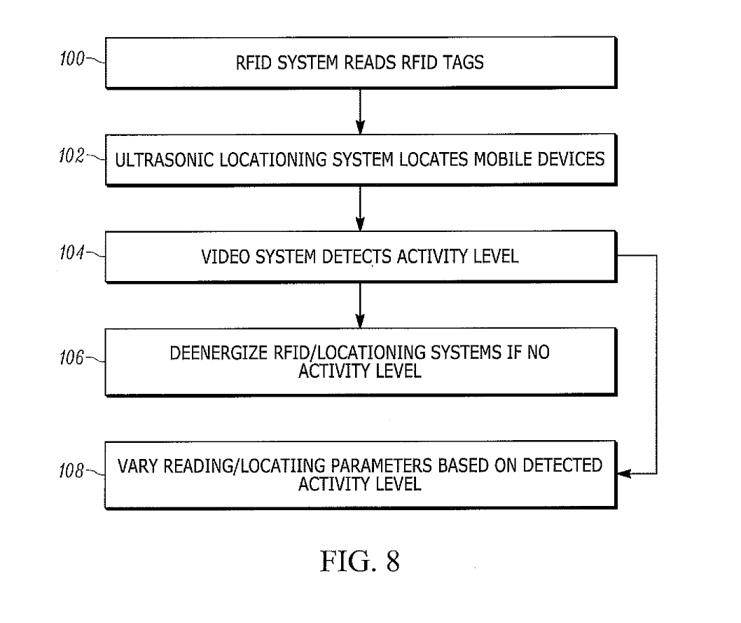

The flow chart of FIG. 8 depicts the operation of the method of this disclosure. In step 100, the RFID system reads the RFID tags with a set of reading parameters, and in step 102, the locationing system locates the mobile devices with a set of locating parameters. In step 104, the video system detects the activity level of the targets in a particular zone. If there is no or zero or a reduced activity level detected, or if the activity level is below a predetermined threshold level, e.g., at idle shelves 96, 98, then the RFID system and/or the locationing system are at least partially deenergized in step 106. If an activity level is detected, or if the activity level is above a predetermined threshold level, e.g., at busy shelves 92, 94, then the reading/locating parameters of the RFID/locationing systems are varied to thereby improve their data capture performance.

In the foregoing specification, specific embodiments have been described. However, one of ordinary skill in the art appreciates that various modifications and changes can be made without departing from the scope of the invention as set forth in the claims below. Although the invention has been described for use with modules 42, 46, 52, 58, different modules, or different combinations of modules, can be mounted in each unit 30. In addition, although the RFID system, the locationing system, the video system, and the communications have been described and illustrated as being mounted in a common housing in each unit 30, this need not be the case, because each system could also be mounted in its own separate housing. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for sensing targets with improved performance in a venue, comprising:
a network server;
a video system deployed in the venue, the video system being operatively connected to, and controlled by, the network server, for detecting a level of activity in the venue; and
a sensing system deployed in the venue, the sensing system being operatively connected to, and controlled by, the network server, for sensing the targets in the venue in response to the activity level detected by the video system.

2. The arrangement of claim 1, wherein the video system includes at least one camera for capturing a video stream of images of the targets over at least one zone in the venue, and wherein the sensing system is operative for sensing the targets in the at least one zone in response to the activity level detected by the at least one camera.

3. The arrangement of claim 1, wherein the sensing system is at least one of a radio frequency (RF) identification (RFID) system operative for reading the targets configured as RFID tags in a reading mode of operation with a set of reading parameters, and a locationing system operative for ultrasonically locating the targets configured as mobile devices in a locating mode of operation with a set of locating parameters; and wherein the network server changes at least one of the reading parameters and the locating parameters based on the activity level detected by the video system.

4. The arrangement of claim 3, wherein the network server controls the RFID system to read fewer RFID tags when a reduced level of activity is detected by the video system, and changes at least one of the reading parameters in which the RFID tags are read based on the activity level detected by the video system.

5. The arrangement of claim 4, wherein the reading parameters include at least one of a dwell time of an RF interrogation signal transmitted by the RFID system, a transmit power at which the RF signal is transmitted, a transmit direction along which the RF signal is transmitted, and a firing order of a plurality of RF signals that are transmitted by the RFID system.

6. The arrangement of claim 3, wherein the network server controls the locationing system to locate fewer mobile devices when a reduced level of activity is detected by the video system, and changes at least one of the locating parameters based on the activity level detected by the video system.

7. The arrangement of claim 6, wherein the locating parameters include at least one of a transmit time of an ultrasonic signal transmitted by the locationing system, a transmit power at which the ultrasonic signal is transmitted, a transmit direction along which the ultrasonic signal is transmitted, and a drive order of a plurality of ultrasonic signals that are transmitted by the locationing system.

8. The arrangement of claim 3, wherein the RFID system, the locationing system, and the video system are all mounted in a common housing mounted at a single overhead location in the venue.

9. The arrangement of claim 8, wherein the common housing has an outer wall bounding an upright axis, wherein the RFID system includes a plurality of RFID antenna elements arranged about the upright axis within the common housing, wherein the locationing system includes a plurality of ultrasonic speakers mounted on the outer wall and arranged about the upright axis, and wherein the video system includes a camera mounted within the common housing and having a lens that faces outwardly of the common housing.

10. A video-controlled arrangement for sensing targets with improved data capture performance in a venue, comprising:
a video system deployed in the venue, for detecting a level of activity in the venue; and
a sensing system deployed in the venue and operatively connected to the video system, for sensing, and capturing data from, the targets in the venue in response to the activity level detected by the video system.

11. The arrangement of claim 10, wherein the sensing system is at least one of a radio frequency (RF) identification (RFID) system operative for reading the targets configured as RFID tags, and a locationing system operative for ultrasonically locating the targets configured as mobile devices.

12. A method of sensing targets with improved performance in a venue, comprising:
deploying and operating a video system in the venue to detect a level of activity in the venue; and
deploying and operating a sensing system in the venue to sense the targets in the venue in response to the activity level detected by the video system.

13. The method of claim 12, and configuring the video system with at least one camera for capturing a video stream of images of the targets over at least one zone in the venue, and wherein the sensing of the targets in the at least one zone is performed in response to the activity level detected by the at least one camera.

14. The method of claim 12, and configuring the sensing system as at least one of a radio frequency (RF) identification (RFID) system operative for reading the targets configured as RFID tags in a reading mode of operation with a set of reading parameters, and as a locationing system operative for ultrasonically locating the targets configured as mobile devices in a locating mode of operation with a set of locating parameters; and changing at least one of the reading parameters and the locating parameters based on the activity level detected by the video system.

15. The method of claim 14, and controlling the RFID system to read fewer RFID tags when a reduced level of activity is detected by the video system, and wherein the changing of the at least one of the reading parameters in which the RFID tags are read is performed based on the activity level detected by the video system.

16. The method of claim 15, wherein the reading parameters include at least one of a dwell time of an RF interrogation signal transmitted by the RFID system, a transmit power at which the RF signal is transmitted, a transmit direction along which the RF signal is transmitted, and a firing order of a plurality of RF signals that are transmitted by the RFID system.

17. The method of claim 14, and controlling the locationing system to locate fewer mobile devices when a reduced level of activity is detected by the video system, and wherein the changing of the at least one of the locating parameters is performed based on the activity level detected by the video system.

18. The method of claim 17, wherein the locating parameters include at least one of a transmit time of an ultrasonic signal transmitted by the locationing system, a transmit power at which the ultrasonic signal is transmitted, a transmit direction along which the ultrasonic signal is transmitted, and a drive order of a plurality of ultrasonic signals that are transmitted by the locationing system.

19. The method of claim 14, and mounting the RFID system, the locationing system, and the video system in a common housing at a single overhead location in the venue.

20. The method of claim 19, and configuring the common housing with an outer wall bounding an upright axis, and configuring the RFID system with a plurality of RFID antenna elements arranged about the upright axis within the common housing, and configuring the locationing system with a plurality of ultrasonic speakers mounted on the outer wall and arranged about the upright axis, and configuring the video system with a camera mounted within the common housing and having a lens that faces outwardly of the common housing.
